(19) United States
(12) Patent Application Publication
(10) Pub. No.: US 2015/0163267 A1
(43) Pub. Date: Jun. 11, 2015

(54) COLLABORATIVE DIGITAL CONTENT STREAMING

(71) Applicant: Collusion US Inc., Saratoga, CA (US)

(72) Inventors: Robert Yearsley, Saratoga, CA (US); Summet Patel, Saratoga, CA (US); Navdeep Saini, Saratoga, CA (US)

(73) Assignee: COLLUSION US INC., Saratoga, CA (US)

(21) Appl. No.: 14/101,337

(22) Filed: Dec. 9, 2013

(51) Int. Cl. H04L 29/06

(52) U.S. Cl. CPC H04L 65/60

(57) ABSTRACT

Briefly, embodiments disclosed herein may relate to collaborative generation and/or editing of content, such as streamed digital content, for example.

### BACKGROUND

1. Field

Subject matter disclosed herein may relate to collaborative generation and/or editing of content, such as streamed digital content, for example.

2. Information

With networks, such as the Internet, gaining tremendous popularity, and with the vast multitude of content, such as pages and/or other documents and/or other media content and/or applications, becoming available to users, such as via the World Wide Web (web), it may be desirable to provide efficient and/or streamlined approaches to generate, display, and/or edit content, such as digital content, that may be desired by and/or useful to a user and/or groups of users, for example. Groups of users, for example, may desire to collaborate to generate and/or edit content, such as digital content, via the Web. In some circumstances, challenges may be faced in providing a satisfactory user experience in collaborative editing of content, such as digital content, through user interaction with client computing devices, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating example interactions among a plurality of client computing platforms and a server computing platform, according to an embodiment.

FIG. 2 is a flow diagram of an example process for facilitating collaborative project streaming, according to an embodiment.

FIG. 3 is an illustration depicting an example project stream, according to an embodiment.

FIG. 4 is a flow diagram of an example process for facilitating collaborative project streaming, according to an embodiment.

FIG. 5 is a schematic diagram illustrating example interactions among a plurality of client computing platforms, according to an embodiment.

FIG. 6 is a schematic diagram illustrating an example computing device in accordance with an embodiment.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

Reference throughout this specification to one implementation, an implementation, one embodiment, an embodiment and/or the like may mean that a particular feature, structure, or characteristic described in connection with a particular implementation or embodiment may be included in at least one implementation or embodiment of claimed subject matter. Thus, appearances of such phrases, for example, in various places throughout this specification are not necessarily intended to refer to the same implementation or to any one particular implementation described. Furthermore, it is to be understood that particular features, structures, or characteristics described may be combined in various ways in one or more implementations. In general, of course, these and other issues may vary with context. Therefore, particular context of description or usage may provide helpful guidance regarding inferences to be drawn.

Operations and/or processing, such as in association with networks, such as communication networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these or similar terms are to be associated with appropriate physical quantities and are intended to merely be convenient labels.

Likewise, in this context, the terms “coupled”, “connected,” and/or similar terms, may be used. It should be understood that these terms are not intended as synonyms. Rather, “connected” may be used to indicate that two or more elements or other components, for example, are in direct physical and/or electrical contact; while, “coupled” may mean that two or more components are in direct physical or electrical contact; however, “coupled” may also mean that two or more components are not in direct contact, but may nonetheless co-operate or interact. The term coupled may also be understood to mean indirectly connected, for example, in an appropriate context.

The terms, “and”, “or”, “and/or” and/or similar terms, as used herein, may include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms may be used to describe any feature, structure, and/or characteristic in the singular and/or may be used to describe a plurality or some other combination of features, structures and/or characteristics. Though, it should be noted that this is merely an illustrative example and claimed subject matter is not limited to this example. Again, particular context of description or usage may provide helpful guidance regarding inferences to be drawn.

It should be understood that for ease of description a network device may be embodied and/or described in terms of a computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

In this context, the term network device refers to any device capable of communicating via and/or as part of a network. Network devices may be capable of sending and/or receiving signals (e.g., signal packets), such as via a wired or wireless network, may be capable of performing arithmetic and/or logic operations, processing and/or storing signals, such as in memory as physical memory states, and/or may, for example, operate as a server. In an embodiment, a server may comprise a cloud hosted platform, for example, although claimed subject matter is not limited in scope in this respect. Network devices capable of operating as a server, such as a cloud-based server, or otherwise, may include, as examples, dedicated rack-mounted servers, desktop computers, laptop computers, set top boxes, tablets, netbooks, smart phones, integrated devices combining two or more features of the foregoing devices, the like or any combination thereof.

A network may comprise two or more network devices and/or may couple network devices so that signal communications, such as in the form of signal packets, for example, may be exchanged, such as between a server and a client device and/or other types of network devices, including between wireless devices coupled via a wireless network, for example. In an embodiment, a server and/or client device may comprise a cloud-based platform, for example. In an embodiment, a “server” may comprise one or more computers forming at least part of a cloud computing system. It is noted that the terms server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices or one or more server devices, as appropriate. In one or more embodiments, client computing devices may communicate with a distributed network of “server” devices as part of a cloud computing system. Along similar lines, references to a “database” are understood to mean one or more databases and/or portions thereof and/or storage, as appropriate.

A network may also include now known, or to be later developed arrangements, derivatives, and/or improvements, including, for example, past, present and/or future mass storage, such as network attached storage (NAS), a storage area network (SAN), cloud-based storage, content delivery network (CDN), and/or other forms of computer and/or machine readable media, for example. A network may include the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures or may be compliant and/or compatible with differing protocols, such as communication protocols (e.g., network communication protocols), may interoperate within a larger network. Various types of devices may be made available so that device interoperability is enabled and/or, in at least some instances, may be transparent to the devices. In this context, the term transparent refers to devices communicating via a network in which the devices are able to communicate via intermediate devices, but without the communicating devices necessarily specifying one or more intermediate devices and/or may include communicating as if intermediate devices are not necessarily involved in communication transmissions. For example, a router may provide a link between otherwise separate and/or independent LANs. In this context, a private network refers to a particular, limited set of network devices able to communicate with other network devices in the particular, limited set, such as via signal packet transmissions, for example, without a need for re-routing and/or redirecting such communications. A private network may comprise a stand-alone network; however, a private network may also comprise a subset of a larger network, such as, for example, without limitation, the Internet. Thus, for example, a private network “in the cloud” may refer to a private network that comprises a subset of the Internet, for example. Although signal packet transmissions may employ intermediate devices to exchange signal packet transmissions, those intermediate devices may not necessarily be included in the private network by not being a source or destination for one or more signal packet transmissions, for example. As another example, a logical broadcast domain may comprise an example of a private network. It is understood in this context that a private network may provide outgoing communications to devices not in the private network, but such devices outside the private network may not direct inbound communications to devices included in the private network.

The Internet refers to a decentralized global network of interoperable networks, including devices that are part of those interoperable networks. The Internet includes local area networks (LANs), wide area networks (WANs), wireless networks, and/or long haul public networks that, for example, may allow signal packets to be communicated between LANs. The terms world wide web (WWW), web, and/or similar terms may also be used, although the terms “WWW” and/or “web” refer to a sub-portion of the Internet that complies with the Hypertext Transfer Protocol or HTTP. It is noted that there are several versions of the Hypertext Transfer Protocol. Signal packets, also referred to as signal packet transmissions, may be communicated between nodes of a network, where a node may comprise one or more network devices, for example. As an illustrative example, but without limitation, a node may comprise one or more sites employing a local network address. Likewise a device, such as a network device, may be associated with that node. A signal packet may, for example, be communicated via a communication channel or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path of network nodes to a target address.

Physically connecting a network via a hardware bridge as one example may be done, although other approaches also exist. A hardware bridge, however, may not typically include a capability of interoperability via higher levels of a network protocol. A network protocol refers to a set of signaling conventions for communications between or among devices in a network, typically network devices; for example, devices that substantially comply with the protocol or that are substantially compatible with the protocol. In this context, the term “between” and/or similar terms are understood to include “among” if appropriate for the particular usage. Likewise, in this context, the terms “compatible with”, “comply with” and/or similar terms are understood to include substantial compliance or substantial compatibility.

Typically, a network protocol has several layers. These layers may be referred to here as a communication stack. Various types of communications may occur across various layers. For example, as one moves higher in a communication stack, additional functions may be available by transmitting communications that are compatible and/or compliant with a particular network protocol at these higher layers. In contrast, a virtual private network (VPN) may enable a remote device to communicate via a local network. A router may allow communications in the form of transmissions (e.g., signal packets), for example, to occur from a remote device to a VPN server on a local network. A remote device may be authenticated and a VPN server, for example, may create a special route between a local network and the remote device through an intervening router.

Although claimed subject matter is not in particular limited in scope to the Internet or to the web, it may without limitation provide a useful example of an embodiment for purposes of illustration. As indicated, the Internet may comprise a worldwide system of interoperable networks, including devices within those networks. The Internet has evolved to a public, self-sustaining facility that may be accessible to tens of millions of people or more worldwide. Also, in an embodiment, and as mentioned above, the terms “WWW” and/or “web” refer to a sub-portion of the Internet that complies with the Hypertext Transfer Protocol or HTTP. The web, therefore, in this context, may comprise an Internet service that organizes stored content, such as, for example, text, images, video, etc., through the use of hypermedia, for example. A HyperText Markup Language (“HTML”), for example, may be utilized to specify content and/or format of hypermedia type content, such as in the form of a file or an “electronic document,” such as a web page, for example. An Extensible Markup Language (XML) may also be utilized to specify content and/or format of hypermedia type content, such as in the form of a file or an “electronic document,” such as a web page, in an embodiment. Of course, HTML and XML are merely example languages provided as illustrations. Claimed subject matter is not intended to be limited to examples provided as illustrations, of course.

As used herein, a “web site” may refer to a collection of related web pages, in an embodiment. Also as used herein, “web page” may relate to any electronic file or electronic document, such as may be accessible via a network, by specifying a URL for accessibility via the web, in an example embodiment. As alluded to above, in one or more embodiments, a web page may comprise content coded using one or more languages, such as, for example, HTML and/or XML, although claimed subject matter is not limited in scope in this respect. Also, in one or more embodiments, application developers may write code in the form of JavaScript, for example, to provide content to populate one or more templates, such as for an application. However, JavaScript is merely an example programming language. As was mentioned, claimed subject matter is not limited to examples or illustrations.

As used herein, the term “entry”, “electronic entry”, “document”, “electronic document”, “content”, “digital content”, “item”, “digital content object” and/or similar terms are meant to refer to signals and/or states in a format, such as a digital format, that may be perceived by a user if displayed and/or otherwise played by a device, such as a digital device, such as, for example, a computing device. For one or more embodiments, an electronic document may comprise a web page coded in a markup language, such as, for example, HTML (hypertext markup language). In another embodiment, an electronic document may comprise a portion or a region of a web page. However, claimed subject matter is not limited in these respects. Also, for one or more embodiments, an electronic document or electronic entry may comprise a number of components. Components in one or more embodiments may comprise text, for example as may be displayed on a web page. Also for one or more embodiments, components may comprise a graphical object, such as, for example, an image, such as a digital image, and/or sub-objects, such as attributes thereof. In an embodiment, digital content may comprise, for example, digital images, digital audio, digital video, and/or other types of electronic documents.

As mentioned, with networks, such as the Internet, gaining tremendous popularity, and with the vast multitude of content, such as pages and/or other documents and/or other media content and/or applications, becoming available to users, such as via the World Wide Web (web), it may be desirable to provide efficient and/or streamlined approaches to generate, display, and/or edit content, such as digital content, that may be desired by and/or useful to a user and/or groups of users, for example. Groups of users, for example, may desire to collaborate to generate and/or edit content, such as digital content, via the Web. In some circumstances, challenges may be faced in providing a satisfactory user experience in collaborative editing of content, such as digital content, through user interaction with client computing devices, for example.

In an embodiment, a plurality of users may desire to collaborate via networked user computing devices to generate and/or to modify content, such as digital content. With conventional cloud-mediated collaboration systems, a user experience may be negatively impacted by situations such as, for example, network transmission congestion, network dropouts, and/or network and/or system latencies. In an embodiment, a user experience, such as with a cloud-based collaboration system, for example, may be enhanced at least in part by providing more efficient communication of modifications made to content, such as digital content, relevant to collaborators, for example. In an embodiment, more efficient communication of content, such as a digital content project, may include streaming content, such as digital content, between two or more user computing devices and may also include user computing devices modifying content and/or communicating modifications to the content while the content is streaming to the user computing devices, for example.

As used herein, the terms “streaming interaction” and/or “streaming” may refer to transmission of content, such as digital content, via a network, such as the Internet, for example, in a manner that provides for the content to be consumed or otherwise interacted with by a user while the content is being delivered. For example, in an embodiment, a digital content project may be edited by one or more users while the digital content project is being transmitted by a server computing platform to one or more user computing devices. In an embodiment, a project may be streamed among a plurality of users, and one or more of the users may specify modifications to the project while the project is being streamed, as explained more fully below. Also, in an embodiment, the terms “streaming interaction” and/or “streaming” may refer to maintaining a communication channel among a plurality of computing devices that provides for modification and multi-casting of content, such as a digital content project, on an ongoing basis, as explained in more detail below. In an embodiment, a digital content project comprises dynamic content, in that the digital content project may be continually modified by one or more users concurrently, and there is no need to completely deliver and/or receive an entire project before changes may be made. As mentioned, modifications may be made to the digital content project while the project is streaming to one or more users. Also, in an embodiment, a collusion project may be maintained in perpetuity, unless the project is deliberately removed, for example, by an authorized user.

Also, as used herein, the terms “digital content project” and/or “project” may refer content, such as digital content, that may be shared and/or edited in a collaborative manner among a plurality of users. In an embodiment, a server may maintain streaming connections among a plurality of users, for example, whereby the plurality of users may share content, such as digital content, in a collaborative manner, as explained in more detail below. Also, as used herein, the terms “project” and/or “digital content project” may refer to streaming content, such as digital content, among a plurality of devices, such as user computing devices, wherein one or more users may specify one or more modifications to the content concurrently with the streaming of the content, as explained more fully below. As also explained more fully below, a project may be edited by one or more users while the project is streaming, in an embodiment. Example types of content, such as digital content, that may comprise a digital content project and that may be collaboratively shared and/or edited, such as during streaming of the digital content, include, but are not limited to, word processing documents, portable document format (PDF) documents, presentation slides, digital image content, digital video content, digital audio content, multimedia content, spreadsheets, web pages, mark-up language documents, such as extensible markup language (XML) documents, line strokes, shaped objects, clip art, sketches, software code, social media content, and/or computer aided design (CAD) drawings, to name a few examples. Of course, claimed subject matter is not limited in scope in these respects.

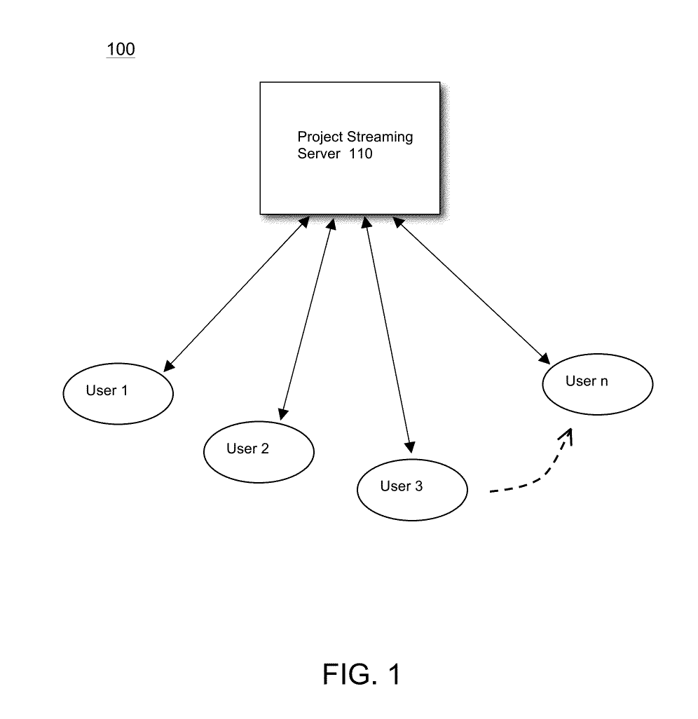

FIG. 1 is a schematic diagram illustrating example interactions among a plurality of client computing devices, such as, user computing device 1, user computing device 2, user computing device 3, user computing device n, and a server computing platform, such as project streaming server 110, according to an embodiment. In an embodiment, project streaming server 110 may comprise a cloud computing platform including one or more networked and/or distributed computing devices, for example. Also, in an embodiment, example user computing devices may include, but are not limited to, tablet devices, laptop computers, personal computers, personal digital assistants, mobile audio and/or video playback and/or recording devices, smartphones, interactive digital whiteboards, touch screen devices, wearable computing devices, augmented reality headset and/or glasses, or any combination of the above. In an embodiment, user computing devices 1 through n may individual comprise, for example, tablet devices, although claimed subject matter is not limited in scope in this respect. For the example depicted in FIG. 1, a plurality of users may desire to collaborate to generate and/or edit content, such as digital content. For example, a plurality of users may wish to collaborate to exchange ideas and/or thoughts utilizing a virtual canvas, for example, although, of course, claimed subject matter is not limited in scope in this respect. Also, in an embodiment, individual users may input line strokes on respective tablet devices, for example, using one or more pen input devices and/or styli.

In an embodiment, content, such as a digital content project, may be transmitted, such as by way of a streaming interaction, from a server computing platform, such as project streaming server 110, to a plurality of user computing devices, such as user computing devices 1 through n. Also, in an embodiment, content, such as a digital content project, may comprise one or more descriptors that individually specify one or more aspects of the content. Further, in an embodiment, one or more additional descriptors specifying modification of one or more aspects of a digital content project may be received at a server, such as at project streaming server 110, from one or more user computing devices, such as from one or more of user computing devices 1 through n.

In an embodiment, user computing devices, such as one or more of user computing devices 1 through n, may specify modification of content, such as a digital content project, while the content is being streamed by a server, such as project streaming server 110, to user computing devices, such as one or more of user computing devices 1 through n. In an embodiment, by allowing users to modify content, such as digital content, while the content is streaming, users may more effectively collaborate on a project, as may be seen in the examples described herein. Also, in an embodiment, communication between a user, such as user 1, and a server, such as project streaming server 110, may comprise bi-directional streaming. With a bi-directional streaming connection, for example, a user computing device may transmit a specification of a modification to content, such as a digital content project, in response to receiving a user interaction from a user while the server is in the process of streaming the content to the user computing device, in an embodiment. In an embodiment, individual user computing devices may be in continual bi-directional communication with other user computing devices taking part in a collaboration. In an embodiment, a server, such as a cloud-based platform, may facilitate bi-directional communication among the various user computing devices.

For example, in an embodiment, a server, such as project streaming server 110, may facilitate streaming content, for example digital content, from a user computing device, such as user computing device 1, to other user computing devices, such as user computing devices 2 through n. For example, digital content indicative of a virtual representation of a whiteboard, referred to herein as a “canvas”, for example, may be streamed from a server, such as project streaming server 110, to a plurality of users, such as users 1 through n. A user computing device, such as user computing device 1, may specify a modification to the virtual canvas, such as by way of a line-stroke, for example, and the modification may be communicated by way of streaming connections to other users, such as user computing devices 2 through n. In an embodiment, a server, such as project streaming server 110, may facilitate streaming digital content from a user computing device, such as user computing device 1, to other user computing devices, such as user computing devices 2 through n.

At least in part in response to receiving content, such as digital content, specifying a modification to the virtual canvas, individual user computing devices, such as user computing devices 2 through n, for example, may perform local modification of the virtual canvas, such that individual user computing devices may maintain local representations of the electronic document. In this manner, various users, such as users 1 through n, may share modifications to content, such as digital content, while the content is being streamed by a server, such as project server 110, to the user computing devices, such as user computing devices 1 through n.

To collaborate using a virtual canvas, for example, one or more users may input line strokes on a tablet device, for example, using one or more pen input devices, or styli. Content, such as digital content, representative of the line strokes may be streamed from one or more tablet devices to other tablet devices, for example. In an embodiment, users may transmit content, such as digital content, representative of line strokes, for example, while other digital content representative of line strokes entered by other users is being streamed. In an embodiment, individual user computing devices, such a tablet devices, may perform modifications to the virtual canvas, for example, in response to receiving content, such as digital content, representative of line strokes entered by other users, and individual user computing devices, such as tablet devices, may maintain and/or display local representations of the virtual canvas, in an embodiment. In this manner, a plurality of users may collaboratively modify a digital content project, such as a virtual canvas, in near real-time. In an embodiment, users may make modifications to content, such as digital content, while content is being streamed to the user's computing devices, for example.

As used herein, the term “descriptor” may refer to content, such as digital content, that may specify one or more actions to be taken in connection with one or more aspects of a digital content project, in an embodiment. For example, in an embodiment, example types of descriptors may include stream descriptors, project descriptors, object descriptors, permission descriptors, user descriptors, account descriptors, and/or activity descriptors, although claimed subject matter is not limited in scope in these respects. Various examples of descriptors are described more fully below.

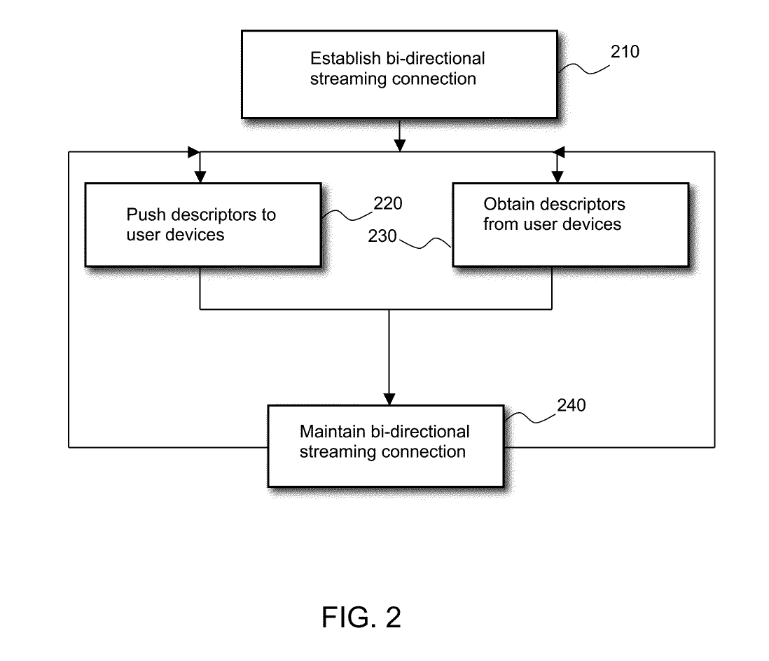

FIG. 2 is a flow diagram of an example process for facilitating collaborative project streaming, according to an embodiment. At block 210, a bi-directional streaming connection may be established between two or more computing devices. For example, in an embodiment, bi-directional streaming connections may be established among a plurality of user computing devices, such as, for example, a plurality of tablet devices, although claimed subject matter is not limited in this respect. At block 220, one or more descriptors may be transmitted via a streaming connection to one or more user computing devices. Also, concurrent with operations depicted at block 220, one or more descriptors may be obtained from one or more other user computing devices, as depicted at block 230. Note that, in an embodiment, descriptors may be obtained from a user computing device while other descriptors are being transmitted to the user computing device. For example, a user may indicate a modification of an electronic document by providing an input to a user computing device, and a descriptor specifying a modification indicated by the user input may be transmitted to one or more other user computing devices while, at approximately the same time, the user computing device may receive other descriptors from the other user computing devices. In an embodiment, a user computing device may not wait to receive a descriptor until the user computing device transmits a particular descriptor. Rather, descriptors may be received and/or transmitted by a user computing device regardless of sequence of descriptor transmissions and/or receptions.

As indicated at block 240, transmission and/or receipt of user descriptors may continue, according to inputs that may be made by a user at a user computing device, for example, and the bi-directional streaming connection may be maintained. In an embodiment, a project may remain open indefinitely. That is, for example, a project may be considered to be open-ended. In a conventional streaming system, for example, a file may be streamed until the entire file is received at a target device. With the conventional streaming server, the streaming connection may be terminated in response to transmitting an entire file, for example. Conversely, in an embodiment, a collaborative streaming connection may be maintained, thereby keeping a user computing device in a state of readiness to receive content related to a collaboration project. Additionally, a user computing device may modify a digital content project at a time of a user's choosing, and other user computing devices involved in the collaboration may be maintained in a state to readily receive modified project content. Because bi-directional streaming communication had already been established for the current example embodiment, changes to a digital content project performed by a user may quickly be communicated to one or more other users, thereby enhancing the users' ability to collaborate, in an embodiment.

In an additional embodiment, at least in part in response to receiving an explicit request from an authorized user computing device to remove a project, a server, such as project streaming server 110, may terminate the bi-directional streaming connections among user computing devices, and/or a digital project object resulting from the terminated collaboration session may be archived, for example. In an embodiment, a digital content project may remain active, with user computing devices remaining in a state of readiness to receive descriptors and/or with bi-directional streaming connections being maintained among user computing devices and/or a streaming project server, until an express request to remove a project is generated by an authorized user computing device, for example. However, as mentioned, claimed subject matter is not limited in scope to the specific examples described herein.

Although FIG. 2 depicts blocks 210-250, other embodiments may include more than or fewer than blocks 210-250. Also, the order of blocks 210-250 is merely an example order, and claimed subject matter is not limited in scope in these respects.

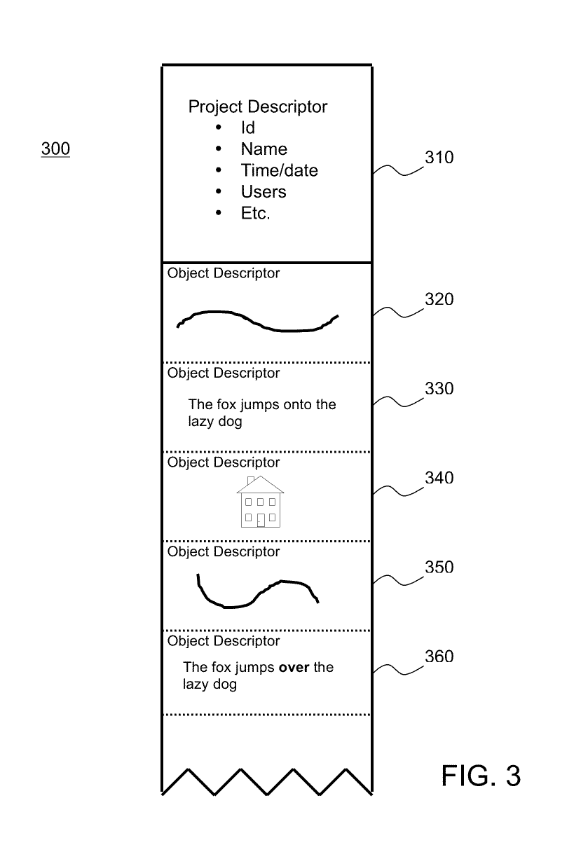

FIG. 3 is an illustration depicting an example embodiment 300 of a digital content project, according to an embodiment. In an embodiment, project 300 may comprise a project descriptor 310 and object descriptors 320-360. In an embodiment, a “project descriptor” may comprise one or more values that may describe a project in general and/or that may specify one or more actions that may be performed on a project overall. For example, actions that may be performed on a project overall may include, but are not limited to, adding a project, modifying a project, removing a project, duplicating a project, and/or reading 1 or n instances of content, such as digital content, for one or more projects. An additional example action that may be specified by a project descriptor may include listing one or more object descriptors related to a specified project, in an embodiment. As also depicted in FIG. 3, project descriptor 310 may further comprise an identification field, a name field, time and/or date information, and/or a listing of one or more users authorized to collaborate on a specified project, for example. In an embodiment, time and/or date information may include timestamp information indicative of when particular operations where performed, such as, for example, when a particular project was created and/or when the project was last modified, although claimed subject matter is not limited in scope in these respects.

As mentioned, project 300 also includes object descriptors 320-360. In an embodiment, an “object” may comprise content, such as digital content, that may comprise a discrete portion of a project. Also, in an embodiment, an “object” may comprise a digital object. In FIG. 3, several example objects are depicted. In an embodiment, objects related to object descriptors 320 and 350 may comprise drawn lines, or strokes, such as may be inputted into a tablet device by a user. For example, a line stroke may be inputted by a user by the user interacting with a touch screen of a tablet device, in an embodiment. An object related to object descriptor 330 may comprise text, and an object related to object descriptor 360 may comprise a modification to text represented by object descriptor 330, in an embodiment. An object related to object descriptor 340 may comprise an image, for example. Of course, these are merely example types of objects, and claimed subject matter is not limited in scope in these respects. In an embodiment, an object may comprise an open-ended range of digital content types, including, but not limited to, audio content, video content, image content, multimedia content, text, and/or drawn lines and/or shapes.

Also, in an embodiment, an “object descriptor” may comprise one or more values that may describe a specified object and/or that may specify one or more actions that may be performed on an object. In an embodiment, an “object descriptor” may comprise one or more indicators of properties and/or values that may allow one or more users to add, list, modify, remove, and/or clear a specified object from a project, to name but a few example operations.

Additionally, in an embodiment, an object descriptor, if combined with other object descriptors of a particular example project, may provide specifications and/or attributes to permit user computing devices having sufficient privileges, for example as specified by a project descriptor, to render a project approximately synchronously with the other user computing devices. For example, user computing devices having privileges to receive streamed descriptor information for a particular project may at least substantially synchronously receive object descriptors sufficient to render a project for display to respective users, in an embodiment.

Object descriptors, in an embodiment, may include one or more “header” fields and/or a “payload” field, for example. In an embodiment, an object descriptor header may include “type” and/or “subtype” fields, for example, and/or may also include a payload field. Example object types may include, but are not limited to, heartbeat messages, error messages, operations, and/or “OK” messages indicating successful receipt of a specified object and/or successful completion of a specified operation, in an example embodiment. Again, claimed subject matter is not limited to the specific examples described herein.

In an embodiment, example payloads may include objects, such as digital content, object identifiers, metadata indicative of one or more line strokes, metadata specifying a shaped object, values indicative of foreground color, background color, metadata specifying type-faced text, object metadata, error correction information, object orientation, and/or a value indicative of payload size. In an embodiment, identifiers may include, but are not limited to, an object identifier (ID), a project ID, a parent project ID, and/or a creator's user ID. Also, in an embodiment, metadata of a line stroke may include, but are not limited to, a position coordinate, a set of coordinates to specify a stroked line, stroke type, a width of a stroke at one or more relevant positions, an indication of a device that created the stroke, orientation of a line stroke, timing of a line stroke, and/or timestamps between individual sets of coordinates. Of course, as mentioned, claimed subject matter is not limited in scope to the particular examples described herein.

Further, in an embodiment, metadata indicative of a shaped object may include, but are not limited to, position coordinate, shape type, orientation, shape border width, border color, fill color, fill gradients, embedded type-faced text, alignment, orientation and/or dimension size, for example. Example metadata of a type-faced text include, for example, uni-coded text, font family, font size, font name, text alignment, starting position, text box dimensions and/or orientation, in an embodiment.

Also, in an embodiment, a “blob-type” object may comprise content, such as digital content, of any type that may be specified and/or defined for a particular implementation, for example. Blob-type objects may include content, such as digital content, including, for example, digital images, video, audio, object coordinates, dimensional and/or size information, overlay features, uniform resource locator (URL) pointing to an object, and/or orientation, in an embodiment.

For the example project 300 depicted in FIG. 3, project descriptor 310 may be generated, for example, by a server computing platform, such as project streaming server 110. In an embodiment, server 110 may generate project descriptor 310 at least in part in response to receiving a request to initiate a project from a user computing device, such as user computing device 1, for example. In response to generating project descriptor 310, server 110 may stream project descriptor 310 to one or more users, such as user computing devices 1-n, for example. Also, for the example depicted in FIG. 3, a user computing device, such as user computing device 1, may generate object descriptor 320, for example, and may transmit object descriptor 320 to a server, such as project streaming server 110, in an embodiment. In an embodiment, object descriptor 320 may represent a line stroke, for example. At least in part in response to receiving object descriptor 320, server 110 may stream object descriptor 320 to user computing devices, such as for user computing devices 1-n, although in some embodiments a server may transmit to user computing devices 2-n because user computing device 1 is already aware of descriptor 320. In other embodiments, server 110 may transmit to user computing devices 1-n, which, for the current example, represent a full set of users having sufficient privileges to participate in the collaboration represented by project 300. User computing devices 1-n, in response to receiving object descriptor 320, may display a line stroke indicated by object descriptor 320.

Continuing with example project 300 depicted in FIG. 3, a user computing device, such as user computing device 2, for example, may generate object descriptor 330, for example in response to a user typing the indicated text. User computing device 2, for example, may transmit object descriptor 330 to a server, such as project streaming server 110, and a server may transmit object descriptor 330 to user computing devices 1-n, in an embodiment. In response to receiving object descriptor 330, user computing devices 1-n may add text indicated by object descriptor to a displayed virtual canvas, together with the previously rendered line stroke of object descriptor 320. Continuing with example project 300, an image indicated by object descriptor 340 may also be added to the display canvas in a manner similar to that described above, as well as a line stroke indicated by object descriptor 350.

Example object descriptor 360 of FIG. 3 represents a correction to previously specified object descriptor 330, in an embodiment. For example, object descriptor 360 may be transmitted by a user, such as one or more of users 1-n, to correct a textual element specified by previously-streamed object descriptor 330. In an embodiment, a plurality of users, such as users 1-n, may continue to make additions, corrections, deletions, and/or other modifications to project 300, and a server, such as server 110, may continue to provide streaming connections for the various user computing devices to enable the users to continue to collaborate in near real-time, for example. In an embodiment, project 300 may continue until such as a user computing device generates a project descriptor indicating to the server to halt the project in some manner, for example.

As used herein, the terms “real-time” and/or “near real-time”, and/or similar terms, may refer to an event and/or situation wherein a time-delay between an occurrence of an event and a subsequent result of an event, such as a response, being relatively short and/or without significant delay. For example, a delay may comprise processing time to handle an event. In an collaborative context, if a user, such as user computing device 1, transmits an object descriptor to a server, such as project streaming service 110, the server may in response deliver the object descriptor to one or more other users, such as user computing devices 1 and 3, for example. In a streaming context, a user computing device may be able to process and/or view one or more object descriptors of a project before completely receiving a project, in an embodiment.

In an embodiment, a project, such as example project 300, may include other descriptor types, including, for example, a “stream” descriptor type. In an embodiment, a stream descriptor may comprise indications of one or more properties and/or values that may describe and/or specify one or more streaming protocol types for communications related to a specified project, for example.

Another descriptor type that may be utilized for a project, such as example project 300, may include a “permission” descriptor type. In an embodiment, a permission descriptor may comprise indications of one or more properties and/or values that specify access permissions for a project owner and/or one or more other users. In an embodiment, a permission descriptor may indicate, for example, read-only, read and modify, read-modify-delete, administrative, and/or owner levels of access, to name but a few examples. In an embodiment, permission-type descriptors may provide for controlled access to collaboration projects. Also, in an embodiment, levels of access may be specified for individual users for specified periods of time, for example, although, of course, claimed subject matter is not limited in scope in these respects.

Additional descriptor types may further include “user” descriptors, account descriptors, and/or activity descriptors. In an embodiment, a user descriptor may comprise one or more properties and/or values indicative of a list of users associated with a specified project, and may further comprise profile information for respective users associated with a specified project. Further, in an embodiment, an account descriptor may comprise one or more properties and/or values provided to enable a user to manage the user's account, such as, for example, enabling a user to log into a system, log out of a system, and/or to modify a user profile. Additionally, an “activity” descriptor may comprise indicators for respective user computing devices and/or server computing platforms identifying online/offline status for the individual devices and/or platforms. Of course, claimed subject matter is not limited in scope to the particular examples described herein.

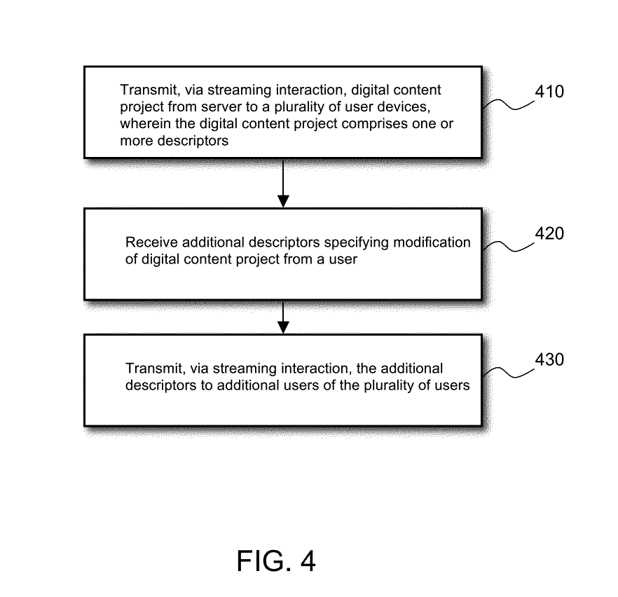

FIG. 4 is a flow diagram of an example process for facilitating collaborative project streaming, according to an embodiment. At block 410, a digital content project may be transmitted via streaming interaction from a server to a plurality of user computing devices. In an embodiment, a digital content project may comprise one or more descriptors, for example. Also, in an embodiment, one or more descriptors specifying a modification of a digital project may be received from a user computing device, as indicated at block 420. At least in part in response to receiving the additional one or more descriptors, the additional descriptors may be transmitted, via streaming interaction, from a server to additional user computing devices of the plurality of user computing devices, for example, as indicated at block 430. Embodiments in accordance with claimed subject matter may include all of, fewer than, or more than blocks 410-430. Also, the order of blocks 410-430 is merely an example order, and claimed subject matter is not limited in scope in this respect.

As noted herein, example embodiments may comprise bi-directional, multicast transmissions of descriptors among user computing devices and/or server computing platforms. Also, in an embodiment, underlying data structures for example projects may specify how files may be rendered in a graphical user interface of a user computing device. Example interactive display type devices for a computing device may include, but are not limited to, tablet devices, laptop computers, personal computers, personal digital assistants, mobile audio and/or video playback and/or recording devices, smartphones, interactive digital whiteboards, touch screen devices, wearable computing devices, augmented reality headset and/or glasses, or any combination of the above. Non-interactive display type devices for a computing device may include, but are not limited to, digital televisions, computer monitors, projectors, epaper devices, and/or large format displays or any combination of the above.

In an embodiment, example projects may be recursive. For example, an object descriptor may refer to a project descriptor of a different project and a set of object descriptors associated with the different project. In an embodiment, a displayed project virtual canvas may comprise one or more regions representative of one or more embedded sub-projects, thereby enabling a user to explore the one or more embedded sub-projects. This is merely an example of the recursive nature of descriptors, and claimed subject matter is not limited in scope in this respect.

Additionally, in an embodiment, due to the nature of networked communication, circumstances may arise wherein object descriptors may arrive at a user computing device, for example, in an order that may be different from the order sent. However, because example embodiments described herein incorporate time-stamping, object descriptors may be handled in the proper order, regardless of the order received. In an embodiment, time-stamping, for example of object descriptors, may allow reversal of actions performed on an object. Also, in an embodiment, time-stamping of events related to various descriptors may allow for a recreation of events related to a project. For example, a collaboration among a number of users may take place, and a project may result in generation of digital content, such as, for example, a marked-up virtual canvas. In an example, a period of time may pass, and questions may arise with respect to the creation of the marked-up virtual canvas. For example, during a collaborative session, a number of ideas may have been proposed and noted on the virtual canvas, and some ideas and/or notes may have been erased and/or replaced with other notes and/or ideas. Because of the time-stamping, a project may be “replayed” and/or analyzed to determine various aspects related to the creation of the marked-up virtual canvas. In an embodiment, a user may review “footage” and/or may review a linear and/or non-linear replay of actual events of a collaborative session to reveal ideas and/or notes that were once part of the marked-up virtual canvas, but that did not wind up on a most recent version of the marked-up virtual canvas, for example. In another embodiment, a user computing device may re-render object descriptors based at least in part on the object descriptor's time stamps, and a user may interact with those objects and/or may add his or her own objects to a project. Of course, these are merely example benefits that may be gleaned through time-stamping related to descriptors, and claimed subject matter is not limited in scope in these respects.

Further, in an embodiment, circumstances may arise wherein multiple users may attempt to modify an object in some manner at approximately the same time. In an embodiment, conflicts such as those described may be avoided by implementing a set of protocols designed to handle any such conflicts. For example, a mechanism may be provided to lock an object prior to a user modifying the object, so that a single user may be allowed to modify the object at any given time. However, this is merely an example protocol-type that may be implemented, and other embodiments are possible utilizing other protocol-types.

In an embodiment, example collaboration systems such as those described herein may be implemented utilizing a guaranteed transport protocol, such as Hypertext Transfer Protocol (HTTP), for example. In an embodiment, an underlying transport layer may handle client-server acknowledgments and/or retry attempts to help ensure deliverability of descriptors, for example.

In one or more embodiments, various optimizations may be implemented with respect to a streaming transmission protocol. For example, digital content may be compressed, in an embodiment, at least in part in response to a content stream exceeding a specified length. Additionally, a set of descriptors may specify actions that may be batched. For example, a set of descriptors may individually specify deletion of individual objects, and such actions may be batched in order to delete a group of objects, for example. Of course, this is merely an example of a set of actions that may be batched, and claimed subject matter is not limited in scope in this respect.

In some circumstances, one or more users may be disconnected from a collaboration session for whatever reason. For example, a user may log off of a system for a period of time, and thus the user computing device may not receive descriptors streamed during that user's absence. In an embodiment, a set of descriptors that a user may not have received, for example if the user computing device was offline for a period of time, may be transmitted to the user computing device so that the user computing device may be synchronized with other computer devices taking part in the collaboration.

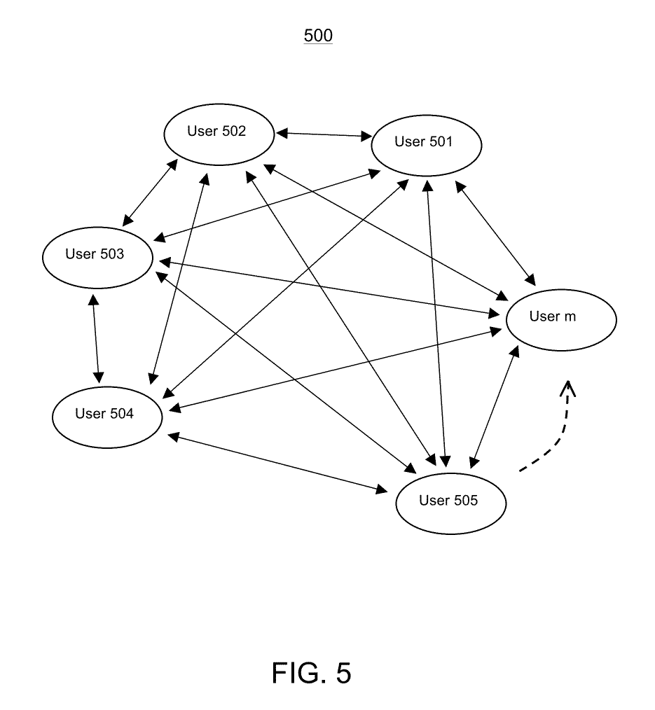

FIG. 5 is a schematic diagram illustrating example interactions among a plurality of client computing platforms of an example system 500, according to an embodiment. In an embodiment, example system 500 may comprise a plurality of user computing devices, including user computing devices 501, 502, 503, 504, 505, and m. User computing devices 501-m, in an embodiment, may communicate one with another without mediation of a server, for example, and may individually stream project, object, and/or other descriptors related to a digital content project to a plurality of other user computing devices. For example, in an embodiment, a user computing device, such as user computing device 501, may initiate a collaboration by transmitting a project descriptor, such as project descriptor 310, to one or more other user computing devices, such as user computing devices 502-m. Additionally, in an embodiment, the various user computing devices may establish streaming connections with one another to facilitate transmission and reception of descriptors, such as descriptors 320-360, for example, to enable collaboration among the various user computing devices. In an embodiment where there is no mediation provided by a server, such as project streaming server 110, individual user computing devices, such as respective user computing devices 501-n, may perform operations similar to those described herein in connection with server 110, for example, although claimed subject matter is not limited in scope in these respects.

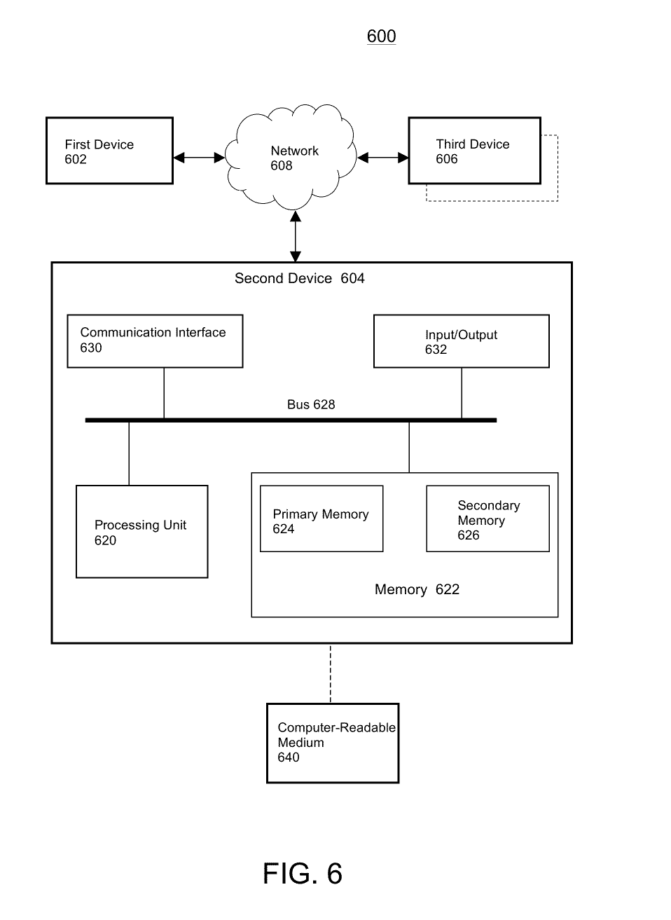

FIG. 6 is a block diagram illustrating an example system 600 comprising a plurality of computing devices coupled via a network 608 in accordance with an embodiment. FIG. 6 includes an illustration of an embodiment of a computing platform or computing device 604 that may be employed in a client-server type interaction, such as described infra. In FIG. 6, computing device 604, which may comprise features of a server computing device, may interface with a computing device 602, which may comprise features of a client device, for example. In other embodiments, computing device 604 may comprise a client computing device, and computing device 602 may comprise a server computing device, for example. In an embodiment, communications interface 630, processor (e.g., processing unit) 620, and memory 622, which may comprise primary memory 624 and secondary memory 626, may communicate by way of communication bus 628, for example. In FIG. 6, computing device 604 may store various forms of content, such as analog, uncompressed digital, lossless compressed digital, or lossy compressed digital formats for content of various types, such as video, imaging, text, audio, etc. in the form physical states or signals, for example. Computing device 604 may communicate with computing device 602 and/or with computing device 606 by way of an Internet connection via network 608, for example. Although the computing device 604 of FIG. 6 shows the above-identified components, claimed subject matter is not limited to computing platforms having only these components as other implementations may include alternative arrangements that may comprise additional components, fewer components, or components that function differently while achieving similar results. Rather, examples are provided merely as illustrations. It is not intended that claimed subject matter to limited in scope to illustrative examples.

Processor 620 may be representative of one or more circuits, such as digital circuits, to perform at least a portion of a computing procedure or process. By way of example but not limitation, processor 620 may comprise one or more processors, such as controllers, microprocessors, microcontrollers, application specific integrated circuits, digital signal processors, programmable logic devices, field programmable gate arrays, and the like, or any combination thereof. In implementations, processor 620 may perform signal processing to manipulate signals or states or to construct signals or states, for example.

Memory 622 may be representative of any storage mechanism. Memory 622 may comprise, for example, primary memory 624 and secondary memory 626, additional memory circuits, mechanisms, or combinations thereof may be used. Memory 622 may comprise, for example, random access memory, read only memory, or one or more data storage devices or systems, such as, for example, a disk drive, an optical disc drive, a tape drive, a solid-state memory drive, just to name a few examples. Memory 622 may be utilized to store a program, as an example. Memory 622 may also comprise a memory controller for accessing computer readable-medium 640 that may carry and/or make accessible content, code, and/or instructions, for example, executable by processor 620 or some other controller or processor capable of executing instructions, for example. Also, in an embodiment, memory 622 may store a local database cache, for example.

Under the direction of processor 620, memory, such as cells storing physical states, representing for example, a program, may be executed by processor 620 and generated signals may be transmitted via the Internet, for example. Processor 620 may also receive digitally-encoded signals from server 604.

Network 608 may comprise one or more communication links, processes, and/or resources to support exchanging communication signals between a client and server, which may, for example, comprise one or more servers (not shown). By way of example, but not limitation, network 608 may comprise wireless and/or wired communication links, telephone or telecommunications systems, Wi-Fi networks, Wi-MAX networks, the Internet, the web, a local area network (LAN), a wide area network (WAN), or any combination thereof.

The term “computing device,” as used herein, refers to a system and/or a device, such as a computer, that includes a capability to process and/or store data in the form of signals and/or states. Thus, a computing device, in this context, may comprise hardware, software, firmware, or any combination thereof (other than software per se). Computing device 604, as depicted in FIG. 6, is merely one such example, and the scope of claimed subject matter is not limited to this particular example. Further, unless specifically stated otherwise, a process as described herein, with reference to flow diagrams and/or otherwise, may also be executed and/or affected, in whole or in part, by a computing device. For one or more embodiments, a computing device may comprise any of a wide range of digital electronic devices. Example computing devices may, for example, be partitioned into “interactive display” type devices and “non-interactive display” type devices. Example interactive display type devices may include, but are not limited to, tablet devices, laptop computers, personal computers, personal digital assistants, mobile audio and/or video playback and/or recording devices, smartphones, interactive digital whiteboards, touch screen devices, wearable computing devices, augmented reality headset and/or glasses, or any combination of the above. Non-interactive display type devices may include, but are not limited to, digital televisions, computer monitors, projectors, epaper devices, and/or large format displays or any combination of the above.

Memory 622 may store cookies relating to one or more users and may also comprise a computer-readable medium that may carry and/or make accessible content, code and/or instructions, for example, executable by processor 620 or some other controller or processor capable of executing instructions, for example. A user may make use of an input device, such as a computer mouse, stylus, track ball, keyboard, or any other device capable of receiving an input from a user.

Regarding aspects related to a communications or computing network, a wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, and/or the like, which may move freely, randomly or organize themselves arbitrarily, such that network topology may change, at times even rapidly. Wireless network may further employ a plurality of network access technologies, including Long Term Evolution (LTE), WLAN, Wireless Router (WR) mesh, or 2nd, 3rd, or 4th generation (2G, 3G, or 4G) cellular technology, or other technologies, or the like. Network access technologies may enable wide area coverage for devices, such as client devices with varying degrees of mobility, for example.

A network may enable radio frequency or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device or a computing device, between or within a network, or the like.

Communications between a computing device and a wireless network may be in accordance with known, or to be developed cellular telephone communication network protocols including, for example, global system for mobile communications (GSM), enhanced data rate for GSM evolution (EDGE), and worldwide interoperability for microwave access (WiMAX). A computing device may also have a subscriber identity module (SIM) card, which, for example, may comprise a detachable smart card that stores subscription information of a user, and may also store a contact list of the user. A user may own the computing device or may otherwise be its primary user, for example. A computing device may be assigned an address by a wireless or wired telephony network operator, or an Internet Service Provider (ISP). For example, an address may comprise a domestic or international telephone number, an Internet Protocol (IP) address, and/or one or more other identifiers. In other embodiments, a communication network may be embodied as a wired network, wireless network, or combination thereof.

A computing device may vary in terms of capabilities or features. Claimed subject matter is intended to cover a wide range of potential variations. For example, a network device may include a numeric keypad or other display of limited functionality, such as a monochrome liquid crystal display (LCD) for displaying text. In contrast, however, as another example, a web-enabled computing device may include a physical or a virtual keyboard, mass storage, one or more accelerometers, one or more gyroscopes, global positioning system (GPS) or other location-identifying type capability, and/or a display with a higher degree of functionality, such as a touch-sensitive color 2D or 3D display, for example.

A computing device may include or may execute a variety of now known, or to be developed operating systems, or derivatives and/or versions, including personal computer operating systems, such as a Windows, iOS or Linux, or a mobile operating system, such as iOS, Android, or Windows Mobile, or the like. A computing device may include or may execute a variety of possible applications, such as a client software application enabling communication with other devices, such as communicating one or more messages, such as via email, short message service (SMS), or multimedia message service (MMS), including via a network, such as a social network including, but not limited to, Facebook, LinkedIn, Twitter, Flickr, or Google+, to provide only a few examples. A computing device may also include or execute a software application to communicate content, such as, for example, textual content, multimedia content, or the like. A computing device may also include or execute a software application to perform a variety of possible tasks, such as browsing, searching, playing various forms of content, including locally stored or streamed video, or games such as, but not limited to, fantasy sports leagues. The foregoing is provided merely to illustrate that claimed subject matter is intended to include a wide range of possible features or capabilities.

A network including a computing device, for example, may also be extended to another device communicating as part of another network, such as via a virtual private network (VPN). To support a VPN, transmissions may be forwarded to the VPN device. For example, a software tunnel may be created. Tunneled traffic may, or may not be encrypted, and a tunneling protocol may be substantially compliant with or substantially compatible with any past, present or future versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, or another existing protocol, or another protocol that may be developed.

A network may be compatible with now known, or to be developed, past, present, or future versions of any, but not limited to the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, or X.25. A network may employ, for example, TCP/IP, UDP, DECnet, NetBEUI, IPX, Appletalk, other, or the like. Versions of the Internet Protocol (IP) may include IPv4, IPv6, other, and/or the like.

It will, of course, be understood that, although particular embodiments will be described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms and/or symbolic representations of operations on binary signals or states, such as stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involves physical manipulation of physical quantities. Typically, although not necessarily, such quantities may take the form of electrical and/or magnetic signals and/or states capable of being stored, transferred, combined, compared, processed or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of processing, manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, as mentioned, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from one or more central concept(s) described herein. Therefore, it is intended that claimed subject matter not be limited to the particular examples disclosed, but that such claimed subject matter may also include all aspects falling within appended claims and/or equivalents thereof.

1. A method, comprising:
transmitting, via streaming interaction, a digital content project from a server computing platform to a plurality of user computing devices utilizing, at least in part, a communication interface of the server computing platform, wherein the digital content project comprises one or more descriptors individually specifying one or more aspects of the digital content project; and
receiving one or more additional descriptors from a first user computing device of the plurality of user computing devices, the one or more additional descriptors to specify modification of one or more aspects of the digital content project; and
transmitting, via streaming interaction, the one or more additional descriptors to one or more of the plurality of user computing devices.

2. The method of claim 1, wherein said receiving the one or more additional descriptors specifying modification of the digital content project comprises receiving the additional descriptors concurrently with said streaming the digital content project, and wherein said transmitting, via streaming interaction, the one or more additional descriptors specifying modification of the digital content project to the one or more of the plurality of user computing devices by transmitting the one or more additional descriptors concurrently with said streaming the digital content project.

3. The method of claim 1, wherein the streaming interaction among the server computing platform and the plurality of user computing devices comprises maintaining a bi-directional streaming connection among the server computing platform and the plurality of user computer devices.

4. The method of claim 3, wherein the bi-directional streaming connection is maintained until a descriptor specifying an end of the streaming connection is received at the server computing platform.

5. The method of claim 1, wherein the one or more descriptors individually specifying one or more aspects of the digital content project comprise one or more project descriptors to specify one or more operations to be performed relative to the digital content project.

6. The method of claim 5, the one or more project descriptors to indicate to individual user computing devices of the plurality of user computing devices to perform the specified one or more operations relative to the digital content project.

7. The method of claim 6, wherein the one or more operations to be performed by the individual user computing devices of the plurality of user computing devices relative to the digital content project comprises creating the digital object project.

8. The method of claim 1, wherein the additional descriptors comprise one or more object descriptors to specify one or more operations to be performed by individual user computing devices of the plurality of user computing devices on one or more specified objects of the digital content project.

9. The method of claim 8, wherein the one or more operations to be performed by the individual user computing devices relative to the one or more specified objects of the digital content project comprises modifying the one or more specified objects.

10. The method of claim 9, wherein the one or more object descriptors individually comprise one or more type fields and a payload field.

11. The method of claim 10, wherein the payload field comprises specifications for drawing a line stroke to be displayed by the one or more user computing devices.

12. The method of claim 1, wherein said receiving the one or more additional descriptors from the first user computing device of the plurality of user computing devices comprises receiving the one or more additional descriptors via a streaming interaction.

13. The method of claim 1, further comprising the server computing platform establishing a streaming connection between the server computing platform and the one or more user computing devices to enable the streaming interaction.

14. The method of claim 1, wherein the plurality of user computing devices comprises a plurality of streaming appliances.

15. The method of claim 14, wherein the plurality of streaming appliances comprises one or more tablet devices.

16. An apparatus, comprising:
a processor to:
initiate transmission, via streaming interaction, of a digital content project to a plurality of user computing devices, wherein the digital content project comprises one or more descriptors individually specifying one or more aspects of the digital content project;
obtain one or more additional descriptors from a first user computing device of the plurality of user computing devices, the one or more additional descriptors to specify modification of one or more aspects of the digital content project; and
initiate transmission, via streaming interaction, of the one or more additional descriptors to one or more of the plurality of user computing devices.

17. The apparatus of claim 16, the processor to obtain the one or more additional descriptors specifying modification of the digital content project concurrently with transmission, via streaming interaction, of the digital content project, the processor further to initiate transmission, via the streaming interaction, of the one or more additional descriptors concurrently with the streaming of the digital content project.

18. The apparatus of claim 16, wherein the streaming interaction among the server computing platform and the plurality of user computing devices comprises maintaining a bi-directional streaming connection among the server computing platform and the plurality of user computer devices.

19. The apparatus of claim 18, wherein the bi-directional streaming connection is maintained until a descriptor specifying an end of the streaming connection is received at the server computing platform.

20. The apparatus of claim 19, wherein the one or more descriptors individually specifying one or more aspects of the digital content project comprise one or more project descriptors to specify one or more operations to be performed relative to the digital content project.

21. The apparatus of claim 20, the one or more project descriptors to indicate to individual user computing devices of the plurality of user computing devices to perform the specified one or more operations relative to the digital content project.

22. The apparatus of claim 21, wherein the one or more operations to be performed by the individual user computing devices of the plurality of user computing devices relative to the digital content project comprises creating the digital object project.

23. The apparatus of claim 16, wherein the additional descriptors comprise one or more object descriptors to specify one or more operations to be performed by individual user computing devices of the plurality of user computing devices on one or more specified objects of the digital content project.

24. The apparatus of claim 23, wherein the one or more operations to be performed by the individual user computing devices relative to the one or more specified objects of the digital content project comprises modifying the one or more specified objects.

25. The apparatus of claim 24, wherein the one or more object descriptors individually comprise one or more type fields and a payload field.

26. The apparatus of claim 25, wherein the payload field comprises specifications for drawing a line stroke to be displayed by the one or more user computing devices.

27. The apparatus of claim 16, wherein said receiving the one or more additional descriptors from the first user computing device of the plurality of user computing devices comprises receiving the one or more additional descriptors via a streaming interaction.

28. The apparatus of claim 16, further comprising the server computing platform establishing a streaming connection between the server computing platform and the one or more user computing devices to enable the streaming interaction.

29. The apparatus of claim 16, wherein the plurality of user computing devices comprises a plurality of streaming appliances.

30. The apparatus of claim 29, wherein the plurality of streaming appliances comprises one or more tablet devices.

31. An article, comprising: a storage medium having stored thereon instructions executable by a processor of a server computing platform to:
initiate transmission, via streaming interaction, of a digital content project to a plurality of user computing devices, wherein the digital content project comprises one or more descriptors individually specifying one or more aspects of the digital content project;
obtain one or more additional descriptors from a first user computing device of the plurality of user computing devices, the one or more additional descriptors to specify modification of one or more aspects of the digital content project; and
initiate transmission, via streaming interaction, of the one or more additional descriptors to one or more of the plurality of user computing devices.

32. The article of claim 31, the storage medium having stored thereon additional instructions executable by the processor of the server computing platform to obtain the one or more additional descriptors specifying modification of the digital content project concurrently with transmission, via streaming interaction, of the digital content project, the storage medium having stored thereon further instructions executable by the processor to initiate transmission, via the streaming interaction, of the one or more additional descriptors concurrently with the streaming of the digital content project.

33. The article of claim 31, wherein the streaming interaction among the server computing platform and the plurality of user computing devices comprises maintaining a bi-directional streaming connection among the server computing platform and the plurality of user computer devices.

34. The article of claim 33, wherein the bi-directional streaming connection is maintained until a descriptor specifying an end of the streaming connection is received at the server computing platform.

35. The article of claim 34, wherein the one or more descriptors individually specifying one or more aspects of the digital content project comprise one or more project descriptors to specify one or more operations to be performed relative to the digital content project.

36. The apparatus of claim 35, the one or more project descriptors to indicate to individual user computing devices of the plurality of user computing devices to perform the specified one or more operations relative to the digital content project.

37. The apparatus of claim 36, wherein the one or more operations to be performed by the individual user computing devices of the plurality of user computing devices relative to the digital content project comprises creating the digital object project.

38. The apparatus of claim 31, wherein the additional descriptors comprise one or more object descriptors to specify one or more operations to be performed by individual user computing devices of the plurality of user computing devices on one or more specified objects of the digital content project.

37. The apparatus of claim 38, wherein the one or more operations to be performed by the individual user computing devices relative to the one or more specified objects of the digital content project comprises modifying the one or more specified objects.

38. The apparatus of claim 37, wherein the one or more object descriptors individually comprise one or more type fields and a payload field.

39. The apparatus of claim 38, wherein the payload field comprises specifications for drawing a line stroke to be displayed by the one or more user computing devices.

40. The apparatus of claim 31, wherein said receiving the one or more additional descriptors from the first user computing device of the plurality of user computing devices comprises receiving the one or more additional descriptors via a streaming interaction.

41. The apparatus of claim 31, further comprising the server computing platform establishing a streaming connection between the server computing platform and the one or more user computing devices to enable the streaming interaction.

42. The apparatus of claim 31, wherein the plurality of user computing devices comprises a plurality of streaming appliances.

43. The apparatus of claim 31, wherein the plurality of streaming appliances comprises one or more tablet devices.
